(19) United States
(12) Patent Application Publication
(10) Pub. No.: US 2007/0176141 A1
(43) Pub. Date: Aug. 2, 2007

(54) Compositions and methods for chemical mechanical polishing interlevel dielectric layers

(76) Inventors: Sarah J. Lane, Elkton, MD (US); Charles Yu, Wilmington, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/342,490

(22) Filed: Jan. 30, 2006

(51) Int. Cl. C09K 13/00

(52) U.S. Cl. 252/79.1

(57) ABSTRACT

The present invention provides an aqueous composition useful for polishing silica and boro-phosphate-silicate-glass on a semiconductor wafer comprising by weight percent 0.01 to 5 carboxylic acid polymer, 0.02 to 6 abrasive, 0.01 to 10 polyvinylpyrrdidone, 0 to 5 cationic compound, 0 to 5 zwitterionic compound and balance water, wherein the polyvinylpyrrolidone has a average molecular weight between 100 grams/mole to 1,000,000 grams/mole.

### BACKGROUND OF THE INVENTION

The invention relates to chemical mechanical planarization (CMP) of semiconductor wafer materials and, more particularly, to CMP compositions and methods for polishing dielectric layers from semiconductor structures in interlevel dielectric (ILD) processes.

Modern integrated circuits are manufactured by an elaborate process where electronic circuits composed of semiconductor devices are integrally formed on a small semiconductor structure. The conventional semiconductor devices that are formed on the semiconductor structure include capacitors, resistors, transistors, diodes, and the like. In advanced manufacturing of integrated circuits, hundreds of thousands of these semiconductor devices are formed on a single semiconductor structure.

Additionally, integrated circuits may be arranged as adjoining dies on a common silicon substrate of the semiconductor structure. Typically, surface level scribe regions are located between the dies, where the dies will be cut apart to form discrete integrated circuits. Within the dies, the surface of the semiconductor structure is characterized by raised regions that are caused by the formation of the semiconductor devices. These raised regions form arrays (“lines”) and are separated by lower regions of lesser height (“spaces”) on the silicon substrate of the semiconductor structure.

Conventionally, the semiconductor devices of the semiconductor structure are formed by alternately depositing and patterning layers of conducting and insulating material on the surface of the semiconductor structure. Frequently, in preparation for the deposition of successive layers, the surface of the semiconductor structure is required to be rendered smooth and flat. Thus, in order to prepare the surface of the semiconductor structure for a material deposition operation, a planarization process is required to be conducted on the surface of semiconductor structure.

Planarization is typically implemented by growing or depositing an interlevel dielectric layer of insulating material such as an oxide or nitride on the semiconductor structure, to fill in rough or discontinuous areas. Interlevel dielectric layers are deposited as a conformal film, causing it to have a non-planar surface characterized by vertically raised protruding features of a greater height extending upward above the lines and by open troughs of a lower height located above the spaces. The planarization process is used to reduce the height (“step-height”) of the vertically protruding features down to a target height that is typically a predefined distance above the level of the tops of the lines where, ideally, a planarized surface will be formed. Currently, CMP is the foremost technique to achieve the desired flatness or planarization. CMP enhances the removal of surface material, mechanically abrading the surface while a chemical composition (“slurry”) selectively attacks the surface.

For example, U.S. Pat. No. 5,391,258 of Brancaleoni, et al. discusses a process for enhancing the polishing rate of silicon, silica or silicon-containing articles including composites of metals and silica. The composition includes about 33 weight percent alumina to enhance the removal rate for the dielectric layer. The composition also includes an oxidizing agent along with an anion that suppresses the rate of removal of the relatively soft silica thin film. The suppressing anion may be any of a number of carboxylic acids.

Boro-Phosphate-Silicate-Glass (BPSG) has been widely used in the semiconductor industry in creating interlayer dielectric films. For these applications, BPSG offers good gap filling and acts as an effective barrier against alkali ion migration towards sensitive device regions. Furthermore, the addition of boron to BPSG films effectively lowers the glass transition temperature of oxide films, enabling oxide films to flow at relatively low temperatures. Thus, BPSG can be used to fill high aspect ratio openings while at the same time providing surface smoothing of the topography of stacked DRAM devices.

Unfortunately, as is well known in the art, the removal rate of BPSG is not easily controlled. This is generally attributed to the concentration of impurity doping of the layer of BPSG and to the heat treatment that the polished layer of BPSG has been subjected to. For example, BPSG has a very high removal rate in both the high features (lines) and the low areas (spaces). Although, due to pressure differences, line oxide (high areas of oxide) typically planarize about twice as fast than the spaces. Hence, since no step-height is desired for the final required oxide thickness, excess oxide is deposited, (i.e., overburden), to allow the line oxide removal to continue until it is substantially planar with the space oxide. In other words, in order to planarize a step-height of 3500 Å, 7000 Å of line oxide and 3500 Å of space oxide must be removed. This requires an excess amount of, at least, 3500 Å of sacrificial overburden oxide to be deposited, requiring added time and expense.

Hence, what is needed is a composition and method for chemical-mechanical polishing of dielectric layers having improved removal rates and selectivity. In particular, what is needed is a composition and method for polishing silica and BPSG in ILD processes, having improved removal rates and selectivity, as well as, improved planarization efficiency.

### STATEMENT OF THE INVENTION

In a first aspect, the present invention provides an aqueous composition useful for polishing silica and boro-phosphate-silicate-glass on a semiconductor wafer comprising by weight percent 0.01 to 5 carboxylic acid polymer, 0.02 to 6 abrasive, 0.01 to 10 polyvinylpyrrolidone, 0 to 5 cationic compound, 0 to 5 zwitterionic compound and balance water, wherein the polyvinylpyrrolidone has an average molecular weight between 100 grams/mole to 1,000,000 grams/mole.

In a second aspect, the present invention provides an a method for polishing silica and silicon nitride on a semiconductor wafer comprising: contacting the silica and boro-phosphate-silicate-glass on the wafer with a polishing composition, the polishing composition comprising by weight percent 0.01 to 5 carboxylic acid polymer, 0.02 to 6 abrasive, 0.01 to 10 polyvinylpyrrolidone, 0 to 5 cationic compound, 0 to 5 zwitterionic compound and balance water, wherein the polyvinylpyrrolidone has an average molecular weight between 100 grams/mole to 1,000,000 grams/mole; and polishing the silica and boro-phosphate-silicate-glass with a polishing pad.

### DETAILED DESCRIPTION OF THE INVENTION

The composition and method provide unexpected improved removal for silicon dioxide and boro-phosphate-silicate-glass on a semiconductor wafer. The composition advantageously comprises polyvinylpyrrolidone for improved selectivity and controllability during the polishing process. In particular, the present invention provides an aqueous composition useful for polishing silica and boro-phosphate-silicate-glass on a semiconductor wafer comprising polyvinylpyrrolidone, carboxylic acid polymer, abrasive and balance water. Optionally, the compound of the present invention may contain a cationic compound to promote planarization, regulate wafer-clearing time and silica removal. Also, the composition optionally contains a zwitterionic compound to promote planarization and serve as a suppressant to boro-phosphate-silicate-glass removal. The inventors have discovered that by capping the BPSG with, for example, silica (e.g., tetraethyl orthosilicate (“TEOS”) oxide) and using the composition of the present invention, it is possible to lower the removal rates of the space oxide as compared to the line oxide, promoting faster planarization times and less overburden oxide. The present invention may provide removal rate ratios between the space oxide and the line oxide of about 0.30 from about 0.50 for a conventional slurry composition.

Advantageously, the novel polishing composition contains about 0.01 to 10 weight percent of polyvinylpyrrolidone to provide the pressure threshold response during oxide removal. Preferably, the polyvinylpyrrolidone is present in an amount of 0.015 to 5 weight percent. More preferably, the polyvinylpyrrolidone is present in an amount of 0.02 to 0.5 weight percent.

Also, the weight average molecular weight of the polyvinylpyrrolidone is 100 to 1,000,000 grams/mole as determined by gel permeation chromatography (GPC). Preferably, the polyvinylpyrrolidone has a weight average molecular weight of 500 to 500,000 grams/mole. More preferably, the weight average molecular weight for the polyvinylpyrrolidone is about 1,500 to about 10,000 grams/mole. In addition, blends of higher and lower number average molecular weight polyvinylpyrrolidone may be used.

In addition to the polyvinylpyrrolidone, the composition advantageously contains 0.01 to 5 weight percent of a carboxylic acid polymer to serve as a dispersant for the abrasive particles (discussed below). Preferably, the composition contains 0.05 to 1.5 weight percent of a carboxylic acid polymer. Also, the polymer preferably has a number average molecular weight of 4,000 to 1,500,000. In addition, blends of higher and lower number average molecular weight carboxylic acid polymers can be used. These carboxylic acid polymers generally are in solution but may be in an aqueous dispersion. The carboxylic acid polymer may advantageously serve as a dispersant for the abrasive particles (discussed below). The number average molecular weight of the aforementioned polymers are determined by GPC.

The carboxylic acid polymers are preferably formed from unsaturated monocarboxylic acids and unsaturated dicarboxylic acids. Typical unsaturated monocarboxylic acid monomers contain 3 to 6 carbon atoms and include acrylic acid, oligomeric acrylic acid, methacrylic acid, crotonic acid and vinyl acetic acid. Typical unsaturated dicarboxylic acids contain 4 to 8 carbon atoms and include the anhydrides thereof and are, for example, maleic acid, maleic anhydride, fumaric acid, glutaric acid, itaconic acid, itaconic anhydride, and cyclohexene dicarboxylic acid. In addition, water soluble salts of the aforementioned acids also can be used.

Particularly useful are “poly(meth)acrylic acids” having a number average molecular weight of about 1,000 to 1,500,000 preferably 3,000 to 250,000 and more preferably, 20,000 to 200,000. As used herein, the term “poly(meth)acrylic acid” is defined as polymers of acrylic acid, polymers of methacrylic acid or copolymers of acrylic acid and methacrylic acid. Blends of varying number average molecular weight poly(meth)acrylic acids are particularly preferred. In these blends or mixtures of poly(meth)acrylic acids, a lower number average molecular weight poly(meth)acrylic acid having a number average molecular weight of 1,000 to 100,000 and preferably, 4,000 to 40,000 is used in combination with a higher number average molecular weight poly(meth)acrylic acid having a number average molecular weight of 150,000 to 1,500,000, preferably, 200,000 to 300,000. Typically, the weight percent ratio of the lower number average molecular weight poly(meth)acrylic acid to the higher number average molecular weight poly(meth)acrylic acid is about 10:1 to 1:10, preferably 5:1 to 1:5, and more preferably, 3:1 to 2:3. A preferred blend comprises a poly(meth)acrylic acid having a number average molecular weight of about 20,000 and a poly(meth)acrylic acid having a number average molecular weight of about 200,000 in a 2:1 weight ratio.

In addition, carboxylic acid containing copolymers and terpolymers can be used in which the carboxylic acid component comprises 5-75% by weight of the polymer. Typical of such polymer are polymers of (meth)acrylic acid and acrylamide or methacrylamide; polymers of (meth)acrylic acid and styrene and other vinyl aromatic monomers; polymers of alkyl (meth)acrylates (esters of acrylic or methacrylic acid) and a mono or dicarboxylic acid, such as, acrylic or methacrylic acid or itaconic acid; polymers of substituted vinyl aromatic monomers having substituents, such as, halogen (i.e., chlorine, fluorine, bromine), nitro, cyano, alkoxy, haloalkyl, carboxy, amino, amino alkyl and a unsaturated mono or dicarboxylic acid and an alkyl (meth)acrylate; polymers of monethylenically unsaturated monomers containing a nitrogen ring, such as, vinyl pyridine, alkyl vinyl pyridine, vinyl butyrolactam, vinyl caprolactam, and an unsaturated mono or dicarboxylic acid; polymers of olefins, such as, propylene, isobutylene, or long chain alkyl olefins having 10 to 20 carbon atoms and an unsaturated mono or dicarboxylic acid; polymers of vinyl alcohol esters, such as, vinyl acetate and vinyl stearate or vinyl halides, such as, vinyl fluoride, vinyl chloride, vinylidene fluoride or vinyl nitriles, such as, acrylonitrile and methacrylonitrile and an unsaturated mono or dicarboxylic acid; polymers of alkyl(meth)acrylates having 1-24 carbon atoms in the alkyl group and an unsaturated monocarboxylic acid, such as, acrylic acid or methacrylic acid. These are only a few examples of the variety of polymers that can be used in the novel polishing composition of this invention. Also, it is possible to use polymers that are biodegradeable, photodegradeable or degradeable by other means. An example of such a composition that is biodegradeable is a polyacrylic acid polymer containing segments of poly(acrylate comethyl 2-cyanoacrylate).

Advantageously, the polishing composition contains 0.2 to 6 weight percent abrasive to facilitate silica removal. Within this range, it is desirable to have the abrasive present in an amount of greater than or equal to 0.5 weight percent. Also, desirable within this range is an amount of less than or equal to 2.5 weight percent.

The abrasive has an average particle size of 50 to 200 nanometers (nm). For purposes of this specification, particle size refers to the average particle size of the abrasive. More preferably, it is desirable to use an abrasive having an average particle size of 80 to 150 nm. Decreasing the size of the abrasive to less than or equal to 80 nm, tends to improve the planarization of the polishing composition, but, it also tends to decrease the removal rate.

Example abrasives include inorganic oxides, inorganic hydroxides, metal borides, metal carbides, metal nitrides, polymer particles and mixtures comprising at least one of the foregoing. Suitable inorganic oxides include, for example, silica (SiO₂), alumina (Al₂O₃), zirconia (ZrO₂), ceria (CeO₂), manganese oxide (MnO₂), or combinations comprising at least one of the foregoing oxides. Modified forms of these inorganic oxides, such as, polymer-coated inorganic oxide particles and inorganic coated particles may also be utilized if desired. Suitable metal carbides, boride and nitrides include, for example, silicon carbide, silicon nitride, silicon carbonitride (SiCN), boron carbide, tungsten carbide, zirconium carbide, aluminum boride, tantalum carbide, titanium carbide, or combinations comprising at least one of the foregoing metal carbides, boride and nitrides. Diamond may also be utilized as an abrasive if desired. Alternative abrasives also include polymeric particles and coated polymeric particles. The preferred abrasive is ceria.

The compounds provide efficacy over a broad pH range in solutions containing a balance of water. This solution's useful pH range extends from at least 4 to 9. In addition, the solution advantageously relies upon a balance of deionized water to limit incidental impurities. The pH of the polishing fluid of this invention is preferably from 4.5 to 8, more preferably a pH of 5.5 to 7.5. The acids used to adjust the pH of the composition of this invention are, for example, nitric acid, sulfuric acid, hydrochloric acid, phosphoric acid and the like. Exemplary bases used to adjust the pH of the composition of this invention are, for example, ammonium hydroxide and potassium hydroxide.

Optionally, the composition advantageously contains 0 to 5 weight percent zwitterionic compound to promote planarization and serve as a suppressant to nitride removal. Advantageously, the composition contains 0.01 to 1.5 weight percent zwitterionic compound. The zwitterionic compound of the present invention may advantageously promote planarization and may suppress nitride removal.

The term “zwitterionic compound” means a compound containing cationic and anionic substituents in approximately equal proportions joined by a physical bridge, for example, a CH₂ group, so that the compound is net neutral overall. The zwitterionic compounds of the present invention include the following structure: 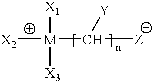
wherein n is an integer, Y comprises hydrogen or an alkyl group, Z comprises carboxyl, sulfate or oxygen, M comprises nitrogen, phosphorus or a sulfur atom, and X₁, X₂ and X₃ independently comprise substituents selected from the group comprising, hydrogen, an alkyl group and an aryl group.

As defined herein, the term “alkyl” (or alkyl- or alk-) refers to a substituted or unsubstituted, straight, branched or cyclic hydrocarbon chain that preferably contains from 1 to 20 carbon atoms. Alkyl groups include, for example, methyl, ethyl, propyl, isopropyl, cyclopropyl, butyl, iso-butyl, tert-butyl, sec-butyl, cyclobutyl, pentyl, cyclopentyl, hexyl and cyclohexyl.

The term “aryl” refers to any substituted or unsubstituted aromatic carbocyclic group that preferably contains from 6 to 20 carbon atoms. An aryl group can be monocyclic or polycyclic. Aryl groups include, for example, phenyl, naphthyl, biphenyl, benzyl, tolyl, xylyl, phenylethyl, benzoate, alkylbenzoate, aniline, and N-alkylanilino.

Preferred zwitterionic compounds include, for example, betaines. A preferred betaine of the present invention is N,N,N-trimethylammonioacetate, represented by the following structure:

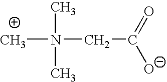

Optionally, the composition of the present invention may comprise 0 to 5 weight percent cationic compound. Preferably, the composition optionally comprises 0.01 to 1.5 weight percent cationic compound. The cationic compound of the present invention may advantageously promote planarization, regulate wafer-clearing time and serve to suppress oxide removal. Preferred cationic compounds include, alkyl amines, aryl amines, quaternary ammonium compounds and alcohol amines. Exemplary cationic compounds include, methylamine, ethylamine, dimethylamine, diethylamine, trimethylamine, triethylamine, aniline, tetramethylammoniumhydroxide, tetraethylammoniumhydroxide, ethanolamine and propanolamine.

Accordingly, the present invention provides a composition useful for polishing silica and BPSG on a semiconductor wafer for ILD processes. The composition advantageously comprises polyvinylpyrrolidone for improved dishing performance. In particular, the present invention provides an aqueous composition useful for polishing silica and BPSG on a semiconductor wafer comprising by weight percent 0.01 to 5 carboxylic acid polymer, 0.02 to 6 abrasive, 0.01 to 10 polyvinylpyrrolidone, 0 to 5 cationic compound, 0 to 5 zwitterionic compound and balance water, wherein the polyvinylpyrrolidone has a average molecular weight between 100 grams/mole to 1,000,000 grams/mole. The composition exhibits particularly improved threshold pressure response at a pH range of 4 to 9.

In addition, the present invention is particularly useful when utilized with a polishing pad, having a reduced rate of wear at or near the center of the wafer track. ILD slurries often exhibit “center-fast” phenomena (i.e., polish at a higher rate at or near the center of the wafer track) relative to the other areas of the wafer. The inventors have discovered that polishing with the composition of the present invention provides improved reduction in center fast phenomena when utilized with a polishing pad having a less aggressive wear rate for the wafer, at or near the center of the wafer track. In other words, the polishing pad has grooves that are configured to provide reduced polishing, proximate the center of the wafer track. The polishing pad may be porous, non-porous or a combination thereof. Also, the polishing pad may have any groove geometry or configuration as desired, for example, spiral, circular, radial, cross-hatched or a combination thereof. A particularly useful groove configuration is a spiral-radial-spiral configuration.

### EXAMPLES

In the Examples, numerals represent examples of the invention and letters represent comparative examples. All example solutions contained, by weight percent, 1.8 ceria, 0.27 polyacrylic acid, 0.5 betaine and 0.15 ethanolamine. The examples of the invention contained 0.1 weight percent polyvinylpyrrolidone. The slurry was prepared by combining an abrasive package with a chemical package. The abrasive package was made by dissolving the polyacrylic acid concentrate in deionized water using a blade mixer and adding the ceria concentrate into the polyacrylic acid solution. Then, the ceria-polyacrylic acid-water mixture was titrated using nitric acid or ammonium hydroxide. The mixture was then fed into a high shear Kady Mill. The chemical package was prepared by dissolving all remaining chemicals into deionized water, in proper amounts, mixing with a blade mixer and titrating to the final pH as desired using nitric acid or ammonium hydroxide. The final slurry is prepared by mixing the abrasive package with the chemical package and titrating to the desired pH.

### Example 1

This experiment measured the effect of the present slurry on the threshold pressure response and selectivity of silicon dioxide and boro-phosphate-silicate-glass removal. In particular, the effect of polyvinylpyrrolidone on the threshold pressure response and selectivity of the silicon dioxide and BPSG removal in the lines and spaces of the test wafer were tested. The “capped” wafers were MIT864™ mask pattern wafers from Sematech having 500 Å TEOS oxide capped on 9500 Å BPSG. The “uncapped” wafers were MIT864™ mask pattern wafers from Sematech having 10,000 Å BPSG. The wafer feature was 50% density @ 1000 micron pitch/500 micron space. Here, 50% density is defined as the spaces in an array of repeated structures wherein the space width/(space width+line width)×100%=50%. For example, if the space width+line width=1000 microns, the 50% space has a width of 500 microns. An Applied Materials Mirra® 200 mm polishing machine using an IC1000™ polyurethane polishing pad (Rohm and Haas Electronic Materials CMP Inc.) under downforce conditions of 1.5 psi and a polishing solution flow rate of 150 cc/min, a platen speed of 52 RPM and a carrier speed of 50 RPM planarized the samples. The polishing solutions had a pH of 6.5 adjusted with nitric acid or ammonium hydroxide. All solutions contained a balance of deionized water.

TABLE 1
Wafer Feature (50% density @ 1000 micron pitch/500 micron space)

| | Polish | Space Thickness | Step Height |
|---|---|---|---|
| | Time (sec) | Loss BPSG (Å) | Remaining (Å) |
| Test A | | | |
| Capped | 140 | 2550 | 45 |
| Non-capped | 140 | 3200 | 40 |
| Example 1 | | | |
| Capped | 150 | 1480 | 24 |
| Non-capped | 150 | 2100 | 265 |

As illustrated in Table 1 above, the addition of the polyvinylpyrrolidone provided a threshold pressure response and selectivity of the composition for silicon dioxide and BPSG. For instance, in Example 1, the composition showed a space thickness loss of only 1480 Å with a step height remaining of 24 Å for the TEOS oxide capped wafer. Also, the composition showed a removal rate ratio of the space/line oxide of 0.31. In other words, the BPSG in the line was removed at a rate that was about three times faster than that of the BPSG in the space. In comparison, the same composition when utilized on the non-capped wafer did not exhibit improved pressure response and selectivity results. For example, the composition (Example 1) showed a space thickness loss of 2100 Å with a step height remaining of 265 Å for the non-capped wafer. Also, the composition showed a removal rate ratio of the space/line oxide of 0.44. In addition, the Test A composition, did not exhibit improved pressure response and selectivity results for either the capped or non-capped wafers. For example, the composition of Test A showed a space thickness loss of 2550 Å for the TEOS oxide capped wafer and 3200 Å for the non-capped wafer. In other words, since the Test A composition did not showed the improved pressure response and selectivity of the composition of the present invention, a much greater loss of BPSG was required before the line/space oxide were substantially planar.

### Example 2

This experiment measured the affect of the present slurry on the threshold pressure response and selectivity of silicon dioxide and boro-phosphate-silicate-glass removal. In particular, the effect of polyvinylpyrrolidone on the threshold pressure response and selectivity of the silicon dioxide and BPSG removal in the lines and spaces of the test wafer were tested. All conditions were similar to that of Example 1 above except that the wafer feature was 90% density.

TABLE 2
Wafer Feature (90% density @ 100 micron pitch/90 micron space)

| | Polish | Space Thickness | Step Height |
|---|---|---|---|
| | Time (sec) | Loss BPSG (Å) | Remaining (Å) |
| Test B | | | |
| Capped | 140 | 3412 | 10 |
| Non-capped | 140 | 4180 | 17 |
| Example 2 | | | |
| Capped | 150 | 2000 | 38 |
| Non-capped | 150 | 2800 | 64 |

As illustrated in Table 2 above, the addition of the polyvinylpyrrolidone provided a threshold pressure response and selectivity of the composition for silicon dioxide and BPSG. For instance, in Example 2, the composition showed a space thickness loss of only 2000 Å with a step height remaining of 38 Å for the TEOS oxide capped wafer. In comparison, the same composition when utilized on the non-capped wafer did not exhibit the same level of improved pressure response and selectivity results. For example, the composition showed a space thickness loss of 2800 Å with a step height remaining of 64 Å for the non-capped wafer. In addition, the Test B composition, did not exhibit improved pressure response and selectivity results for either the capped or non-capped wafers. For example, the composition of Test B showed a space thickness loss of 3412 Å for the TEOS oxide capped wafer and 4180 Å for the non-capped wafer. In other words, since the Test B composition did not show the improved pressure response and selectivity of the composition of the present invention, a much greater loss of BPSG was required before the line/space oxide were substantially planar.

### Example 3

This experiment measured the affect of the present slurry on the threshold pressure response and selectivity of silicon dioxide and boro-phosphate-silicate-glass removal. In particular, the effect of polyvinylpyrrolidone on the threshold pressure response and selectivity of the silicon dioxide and BPSG removal in the lines and spaces of the test wafer were tested. All conditions were similar to that of Example 1 above except that the wafer feature was 10% density.

TABLE 3
Wafer Feature (10% density @ 100 micron pitch/10 micron space)

| | Polish | Space Thickness | Step Height |
|---|---|---|---|
| | Time (sec) | Loss BPSG (Å) | Remaining (Å) |
| Test C | | | |
| Capped | 140 | 2600 | 35 |
| Non-capped | 140 | 4100 | 35 |
| Example 3 | | | |
| Capped | 150 | 1600 | 29 |
| Non-capped | 150 | 2140 | 93 |

As illustrated in Table 3 above, the addition of the polyvinylpyrrolidone provided a threshold pressure response and selectivity of the composition for silicon dioxide and BPSG. For instance, in Example 3, the composition showed a space thickness loss of only 1600 Å with a step height remaining of 29 Å for the TEOS oxide capped wafer. In comparison, the same composition when utilized on the non-capped wafer did not exhibit the same level of improved pressure response and selectivity results. For example, the composition showed a space thickness loss of 2140 Å with a step height remaining of 93 Å for the non-capped wafer. In addition, the Test C composition, did not exhibit improved pressure response and selectivity results for either the capped or non-capped wafers. For example, the composition of Test C showed a space thickness loss of 2600 Å for the TEOS oxide capped wafer and 4100 Å for the non-capped wafer. In other words, since the Test C composition did not showed the improved pressure response and selectivity of the composition of the present invention, a much greater loss of BPSG was required before the line/space oxide were substantially planar.

Accordingly, the present invention provides a composition useful for polishing silica and boro-phosphate-silicate-glass on a semiconductor wafer for shallow trench isolation processes. The composition advantageously comprises polyvinylpyrrolidone for improved selectivity and controllability during the polishing process. In particular, the present invention provides an aqueous composition useful for polishing silica and boro-phosphate-silicate-glass on a semiconductor wafer comprising polyvinylpyrrolidone, carboxylic acid polymer, abrasive and balance water. Optionally, the compound of the present invention may contain a cationic compound to promote planarization, regulate wafer-clearing time and silica removal. Also, the composition optionally contains a zwitterionic compound to promote planarization and serve as a suppressant to BPSG removal. Note, while the embodiments of the invention described above use TEOS oxide capped BPSG, the invention is not so limited. For example, the composition of the present invention may be utilized on TEOS oxide capped phosphoresilicate glass (PSG), borosilicate glass (BSG), high density plasma (HDP) silicon oxide layer, an undoped silicate glass (USG), a high thermal (HT)-USG, or a plasma enhanced (PE)-silicon oxide layer.

1. An aqueous composition useful for polishing silica and boro-phosphate-silicate-glass on a semiconductor wafer comprising by weight percent 0.01 to 5 carboxylic acid polymer, 0.02 to 6 abrasive, 0.01 to 10 polyvinylpyrrolidone, 0 to 5 cationic compound, 0 to zwitterionic compound and balance water, wherein the polyvinylpyrrolidone has an average molecular weight between 100 grams/mole to 1,000,000 grams/mole.

2. The composition of claim 1 wherein the composition comprises 0.02 to 1 weight percent polyvinylpyrrolidone.

3. The composition of claim 1 wherein the polyvinylpyrrolidone has a average molecular weight between 1,500 grams/mole to 10,000 grams/mole.

4. The composition of claim 1 wherein the zwitterionic compound has the following structure: 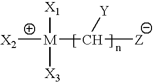
wherein n is an integer, Y comprises hydrogen or an alkyl group, Z comprises carboxyl, sulfate or oxygen, M comprises nitrogen, phosphorus or a sulfur atom, and X₁, X₂ and X₃ independently comprise substituents selected from the group comprising, hydrogen, an alkyl group and an aryl group.

5. The composition of claim 1 wherein the carboxylic acid polymer is a polyacrylic acid.

6. The composition of claim 1 wherein the cationic compound is selected from the group comprising: alkyl amines, aryl amines, quaternary ammonium compounds and alcohol amines.

7. The composition of claim 1 wherein the abrasive is ceria.

8. The composition of claim 1 wherein the aqueous composition has a pH of 4 to 9.

9. A method for polishing silica and boro-phosphate-silicate-glass on a semiconductor wafer comprising:
contacting the silica and silicon nitride on the wafer with a polishing composition, the polishing composition comprising by weight percent 0.01 to 5 carboxylic acid polymer, 0.02 to 6 abrasive, 0.01 to 10 polyvinylpyrrolidone, 0 to 5 cationic compound, 0 to 5 zwitterionic compound and balance water, wherein the polyvinylpyrrolidone has an average molecular weight between 100 grams/mole to 1,000,000 grams/mole; and
polishing the silica and boro-phosphate-silicate-glass with a polishing pad.

10. The method of claim 9 wherein the composition comprises 0.02 to 1 weight percent polyvinylpyrrolidone.
